(19) United States
(12) Patent Application Publication
(10) Pub. No.: US 2013/0212498 A1
(43) Pub. Date: Aug. 15, 2013

(54) Selecting Content Within a Web Page

(71) Applicants: Suk Hwan Lim, Palo Alto, CA (US); Hui-Man Hou, Beijing (CN); Li-Wei Zheng, Beijing (CN); Jian-Ming Jin, Beijing (CN); Marie Bird Struckaman, Westminster, CO (US); Rachel L. Ramaswami, Frisco, TX (US); Hua Zhang, Shanghai (CN); Yue Yuan, Shanghai (CN)

(72) Inventors: Suk Hwan Lim, Palo Alto, CA (US); Hui-Man Hou, Beijing (CN); Li-Wei Zheng, Beijing (CN); Jian-Ming Jin, Beijing (CN); Marie Bird Struckaman, Westminster, CO (US); Rachel L. Ramaswami, Frisco, TX (US); Hua Zhang, Shanghai (CN); Yue Yuan, Shanghai (CN)

(21) Appl. No.: 13/812,800

(22) PCT Filed: Jul. 30, 2010
(86) PCT No.: PCT/CN2010/001158

§ 371 Date: Mar. 25, 2013

(51) Int. Cl. G06F 3/0481

(52) U.S. Cl. CPC G06F 3/0481
USPC 715/760

(57) ABSTRACT

A system and method of selecting content within a web page (110, 300) may include, with a processor (125), determining spatial coordinates of a plurality of nodes (210 through 285) within the web page (110, 300), recording coordinates of a drawn portion (610) of the web page (110, 300), and determining, with the processor (125), a number of corresponding regions (710, 910) for the drawn portion (610) of the web page (110, 300) based on the spatial coordinates of the nodes (210 through 285).

### BACKGROUND

A wide variety of digital content is available to users through a variety of electronic devices. For example, users often browse digital content on their personal computers, mobile phones, and other types of computing systems. Digital content is typically displayed to users through graphical user interfaces. The content may include images, text, and other visual items. A graphical user interface allows a user to interact with the displayed content via a type of input device such as a mouse, track pad, or touch screen. A user is generally provided with a number of tools such as a cursor that can change its appearance based on actions being performed within the graphical user interface.

When graphical content is displayed to a user, it is often accompanied by a set of undesirable or irrelevant content. For example, when a user is browsing content on a web page through a web browser, it is often the case that the user must sort through advertisements and navigational objects to find the desired or relevant portion of the content presented. A user may desire to print a physical copy of a portion if the text of an article within a web page without reproducing any of the irrelevant content on the web page containing the article. Similarly, an owner of a web page may wish to adapt a web page into another document, such as a marketing brochure, without including content in the web page that is superfluous to the new document. Such uses of only a portion of the content presented in a web page can require tedious effort on the part of a user to distinguish among the different types of content on the web page and retrieve only the desired content.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative system for detecting separator lines in a web page, according to one example of principles described herein.

FIG. 2 is a block diagram of a document object model (DOM) tree for an illustrative web page, according to one example of principles described herein.

FIG. 3 is a layout of an illustrative web page corresponding to the document object model (DOM) tree of FIG. 2, according to one example of principles described herein.

FIG. 4 is a flow chart depicting an illustrative method for selecting content within a web page, according to one example of principles described herein.

FIG. 5 is a flow chart depicting an illustrative method for selecting and displaying content of a web page after an initial selection by a user, according to one example of principles described herein.

FIG. 6 is a diagram of the web page of FIG. 3 in which a user has drawn an approximate region of the web page for selection, according to one example of principles described herein.

FIG. 7 is a diagram of the web page of FIGS. 3 and 6 after computation of the corresponding node of the user's drawn approximate region, according to one example of principles described herein.

FIG. 8 is a diagram of the web page of FIG. 3 in which a user has drawn an approximate region of the web page for selection, according to another example of principles described herein.

FIG. 9 is a diagram of the web page of FIGS. 3 and 8 displaying several corresponding regions after computation of the corresponding nodes of the user's drawn approximate region, according to another example of principles described herein.

Throughout the drawings, identical reference numbers designate similar, but not necessarily identical, elements.

### DETAILED DESCRIPTION

The present specification discloses various methods, systems, and devices for selecting content within a web page. As discussed above, web pages include a variety of content including text and images. Some of the content is selectable and print-worthy. However, some content on web pages is auxiliary content that the user may not desire to select or print. For example, undesirable auxiliary content may include advertisements, background imagery, navigational bars and menus, links to additional content, headers, and footers, among others. In many web-based applications, it is desirable to allow the user to select the content he or she wants to select given a web page or multiple web pages.

Some challenges to providing a user with the capability to select content within web pages may include, for example, the fact that web page layouts vary widely across different web sites, and that web pages include a variety of different types of content including text and images. Further, it is challenging to capture the true granularity of the content that the user desires. For example, it is often not clear whether the user wants a single word, a paragraph, or the entire article. Still further, in order to print a portion of the web page properly, the selection of content should be robustly tracked and reproduced if desired by the user. Even still further, the user should be able to select content within the web page quickly and effectively without requiring the user to apply too complicated of a process.

There are a number of means to allow a user to select content within an area. One such solution is a screen shot-based solution. A screen shot-based process allows a user to treat a web page as an image and draw on the image. The user would indicate what content he or she desires by drawing around the portion precisely. A disadvantage of this screen shot-based solution is that the user may be too precise about the selection. In addition, the selected portion does not strictly correspond to the actual content of the web page, so it is difficult to use the selected content for other applications. For example, the print quality of a cropped area would not be high due to the resolution, and therefore, a resulting print out of the content would be difficult or impossible to read.

Another solution is a click-based solution. A click-based solution would allow a user to click on elements within the web page that the user desires, and may include applications such as web clipping applications. However, a disadvantage of this method is that it is very difficult for a computing system to infer the granularity of the desired portion of the web page. For example, when the user clicks on an article in a web page, the system cannot determine whether the user meant a single word, a sentence, a paragraph, or the entire article. Thus, this method can be ambiguous in supplying the user with a desired and appropriate selection.

Yet another solution is a gesture-based solution. A gesture-based method provides the user with a pen to draw on the web page. The system determines how to select contents based on path of the pen. Thus, this method allows the user to specify the scale of the desired content better than the click-based solution. However, this is nota user-friendly environment to which the user is accustomed. Further, since a gesture-based solution is dependent on the line-path of the user gesture, there are still some ambiguities in inferring the scale of the selected portion of the web page from each of the gestures.

As used in the present specification and in the appended claims, the term “web page” refers to a document that can be retrieved from a server over a network connection and viewed in a web browser application. Further, as used in the present specification and in the appended claims, the term “node” refers to one of a plurality of coherent units into which the entire content of a web page has been partitioned.

Further, as used in the present specification and in the appended claims, the term “granularity” refers broadly to the size and extent of the subdivision of a web page that a user is capable of selecting. Further, as used in the present specification and in the appended claims, the term “Document Object Model” or “DOM” is meant to be understood broadly as a system in which a structured document, for example an XML file, is viewed as a tree of objects that can be programmatically accessed, analyzed, and updated.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

According to one example of the principles described herein, a computer readable storage medium may be, for example, but not limited to, an electronic, magnetic, optical, electromagnetic, infrared, or semiconductor system, apparatus, or device, or any combination thereof. More specifically, the computer readable storage medium may be an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination thereof. Computer program code for carrying out operations of the present specification may be written in an object oriented programming language such as Java, Smalltalk, C, C++, among others. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

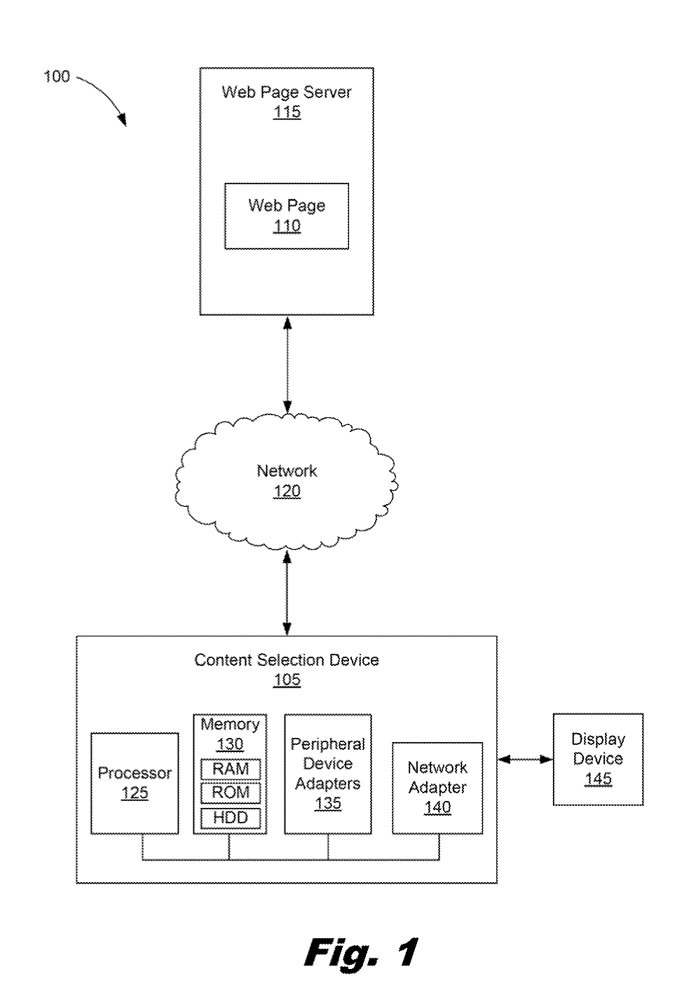

Referring now to FIG. 1, an illustrative system (100) for selecting content within a web page (110) may include a content selection device (105) that has access to a web page (110) stored by a web page server (115). In the present example, for the purposes of simplicity in illustration, the content selection device (105) and the web page server (115) are separate computing devices communicatively coupled to each other through a mutual connection to a network (120). However, the principles set forth in the present specification extend equally to any alternative configuration in which a content selection device (105) has complete access to a web page (110). As such, alternative examples within the scope of the principles of the present specification include, but are not limited to, examples in which the content selection device (105) and the web page server (115) are implemented by the same computing device, examples in which the functionality of the content selection device (105) is implemented by multiple interconnected computers (e.g., a server in a data center and a user's client machine), examples in which the content selection device (105) and the web page server (115) communicate directly through a bus without intermediary network devices, and examples in which the content selection device (105) has a stored local copy of the web page (110) from which content is selected.

In one example utilizing a network (120), the network (120) may be any number of computing devices or elements physically connected for the purpose of exchanging data. The network (120) may include, for example, a local area network (LAN), a wide area network (WAN), a virtual private network (VPN), and the Internet, among others.

The content selection device (105) of FIG. 1 may be a computing device that retrieves the web page (110) hosted by the web page server (115) and determines user-selected content within the web page (110). In the present example, this is accomplished by the content selection device (105) first requesting the web page (110) from the web page server (115) over the network (120) using the appropriate network protocol (e.g., Internet Protocol (“IP”)). Illustrative processes of selecting content within a web page will be set forth in more detail below.

To achieve its desired functionality, the content selection device (105) includes various hardware components. Among these hardware components may be at least one processor (125), at least one memory unit (130), peripheral device adapters (135), and a network adapter (140). These hardware components may be interconnected by one or more busses and/or network connections.

The processor (125) may include the hardware architecture to retrieve executable code from the memory unit (130) and execute the executable code. The executable code may, when executed by the processor (125), cause the processor (125) to implement at least the functionality of retrieving the web page (110) and determine user-selected content within the web page (110) according to the methods of the present specification described below. In the course of executing code, the processor (125) may receive input from and provide output to one or more of the remaining hardware units.

The memory unit (130) may digitally store data consumed and produced by the processor (125). The memory unit (130) may include various types of memory modules, including volatile and nonvolatile memory. For example, the memory unit (130) of the present example includes Random Access Memory (RAM), Read Only Memory (ROM), and Hard Disk Drive (HDD) memory. As discussed above, many other types of memory are available in the art, and the present specification contemplates the use of any type(s) of memory (130) in the memory unit (130) as may suit a particular application of the principles described herein. In certain examples, different types of memory in the memory unit (130) may be used for different data storage needs. For example, in certain examples the processor (125) may boot from ROM, maintain nonvolatile storage in the HDD memory, and execute program code stored in RAM.

The hardware adapters (135, 140) in the content selection device (105) enable the processor (125) to interface with various other hardware elements, external and internal to the content selection device (105). For example, peripheral device adapters (135) may provide an interface to input/output devices to create a user interface and/or access external sources of memory storage. Peripheral device adapters (135) may also create an interface between the processor (125) and, for example, a printer, display device (145), or other peripheral device.

A network adapter (140) may provide an interface to the network (120), thereby enabling the transmission of data to and receipt of data from other devices on the network (120), including the web page server (115). The web page server (115) may be any combination of hardware and software capable of servicing Hypertext Transfer Protocol (HTTP) requests.

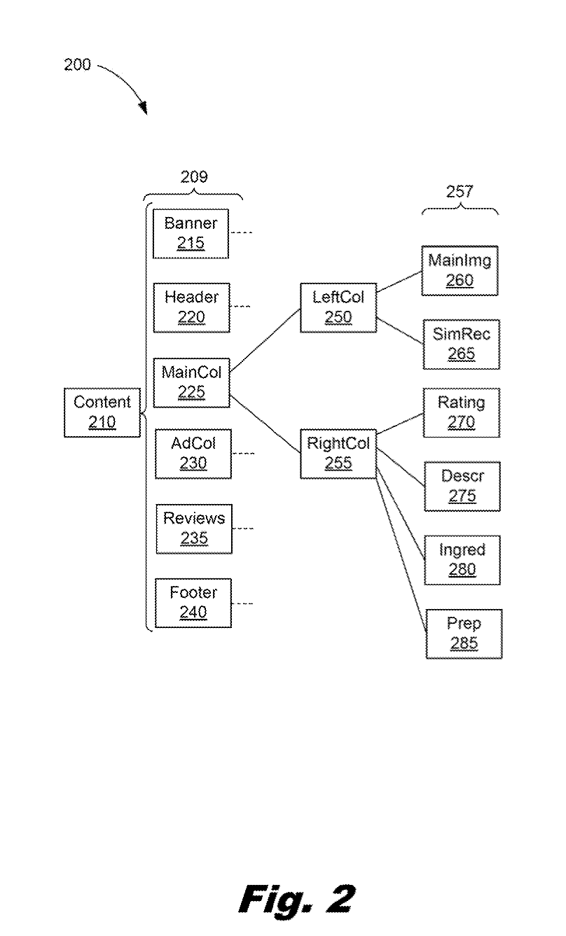

FIG. 2 is a block diagram of a document object model (DOM) tree (200) for an illustrative web page (110, 300), according to one example of principles described herein. FIG. 2 depicts a hierarchy of DOM nodes in the web page (110, 300). DOM is a cross-platform and language independent convention for representing and interacting with web page elements in hypertext markup language (HTML), extensible hypertext markup language (XHTML) and extensible markup language (XML). The nodes within a DOM tree may include a number of nodes including a root node (210), a number of leaf nodes (generally 257, and specifically, 260, 265, 270, 275, 280, 285), and a number of intermediary nodes (215, 220, 225, 230, 235, 240, 250, 255).

In FIG. 2, each of the nodes in the DOM tree is labeled with a name and a tag. For example, the banner node (215) is named “Banner” and is labeled with a division tag (“<div>”). The DOM tag “<div>” indicates that styles in this node are defined in Cascading Style Sheets (CSS) language. Additionally, the DOM tag “<img>” indicates the presence of an image; a “<p>” tag indicates a paragraph; and a “<ui>” tag indicates a list.

The root node in this DOM tree is the Content node (210) which has six sub-trees (209): Banner (215); Header (220); MainCol (225); Adcol (230); Reviews (235); and Footer (240). For purposes of illustration, subnodes (250-285) are shown for only for the MainCol sub-tree (225). Dashed lines extending to the right of the other sub-trees show the continuation of the sub-trees with nodes which are not illustrated in FIG. 2.

The MainCol sub-tree (225) has two nodes, LeftCol (250) and RightCol (255), at the next hierarchal level. LeftCol (250) has two nodes at the lowest hierarchal level (257): MainImg (260) and SimRec (265). The RightCol (255) has four nodes at the lowest hierarchal level (257): Rating (270), Descr (275), Ingred (280), and Prep (285). The nodes at the lowest hierarchal level (257) are called leaf nodes, as indicated above.

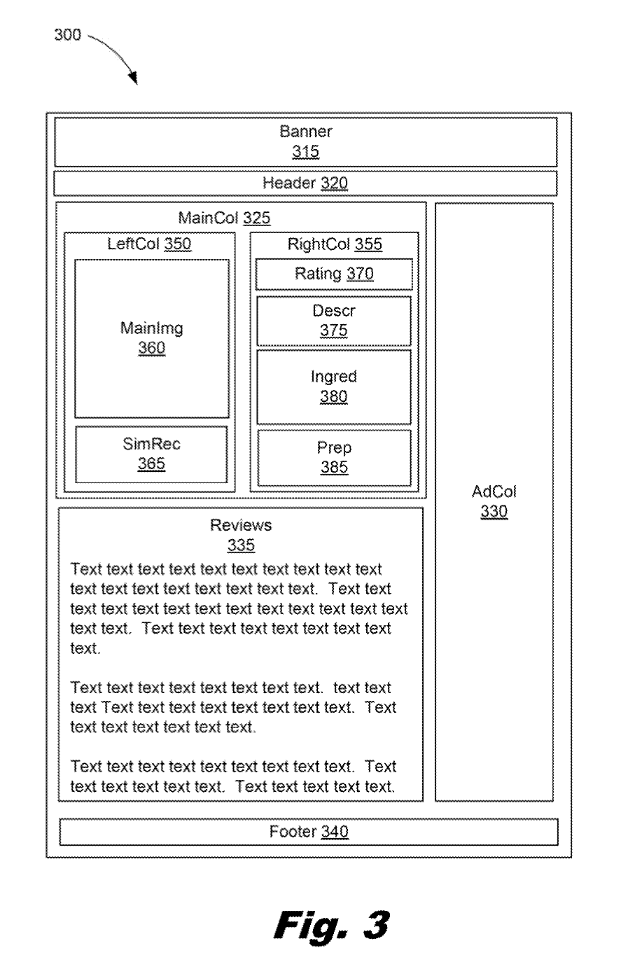

FIG. 3 is a layout of an illustrative web page (110, 300) corresponding to the document object model (DOM) tree of FIG. 2, according to one example of principles described herein. FIG. 3 depicts regions in a web page (110, 300) which correspond to the various elements in the DOM tree (200, FIG. 2). The Banner (315) and AdCol (330) elements reserve locations in the web page (110, 300) for a banner ad and other advertisements. The Header (320) may contain a number of elements including navigation tabs, search fields, and other sub-elements. Similarly, the Footer (340) may contain a number of elements including links to related sites, terms of use and privacy policies, copyright notices, and other elements. The Reviews sub-tree (335) may contain ratings and comments from various users of the site who have tried the recipe.

In this example, the MainCol (325) element contains the “main content” which a user would typically print or archive for further reference. The MainCol (325) contains a left column (350) and a right column (355). In one example, in left column (350), an image of a dish associated with a recipe available on the web page (110, 300) may be shown in the MainImg element (360). Further, although not depicted, similar recipes may be shown below the image in the SimRec element (365). The right column (255) may include an overall rating for the dish (370), a description of the dish (375), ingredients of the dish (380), and preparation instructions (385) as text elements, image elements, link elements, interactive elements, and combinations thereof. These elements (360-385) may have a number of additional subelements.

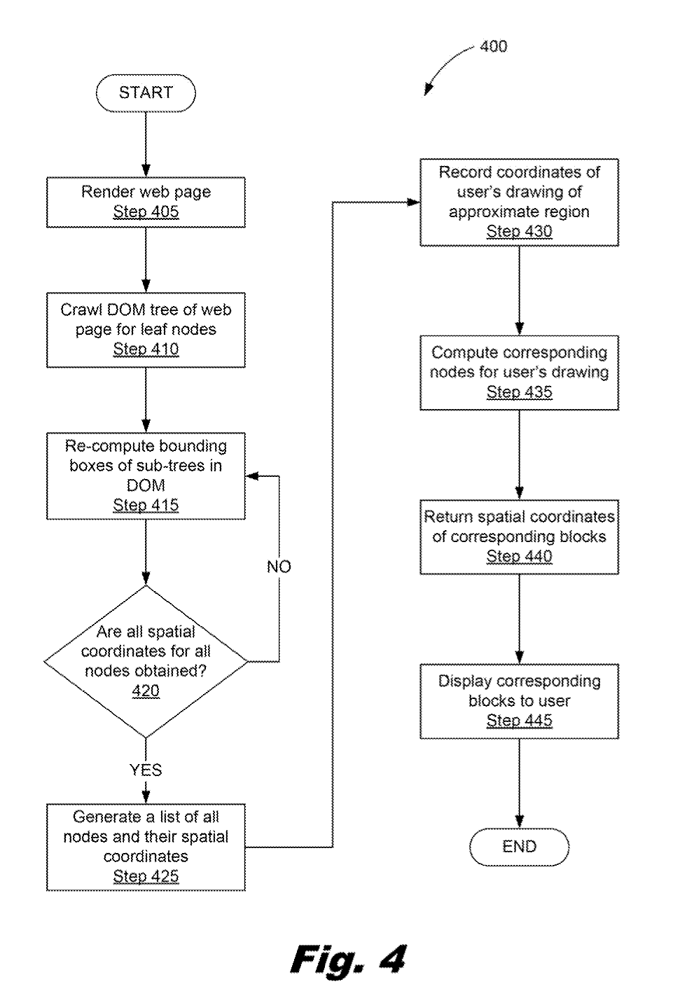

Turning now to FIG. 4, a flow chart depicting an illustrative method for selecting content within a web page (110, 300), according to one example of principles described herein is depicted. The selection of content within a web page (110, 300) may begin with rendering a web page (110, 300) (Step 405). This may be accomplished by, for example, the content selection device (105) of FIG. 1 in which the content selection device (105) retrieves the web page (110, 300) hosted by the web page server (115). More specifically, the content selection device (105) may include a web browser stored in memory (130). The web browser is a client program that initiates requests for a web page (110, 300) to a web page server (115) via the network (120), and renders and displays the web page (110, 300) that the server returns. The web browser may be WINDOWS® INTERNET EXPLORER® (using the TRIDENT® engine), MOZILLA® FIREFOX® (using the GECKO® engine), or WEBKIT®, for example.

Next, the content selection device (105) may then crawl the DOM tree (200), and identify and gather all contents within the leaf nodes (generally 257, and specifically, 260, 265, 270, 275, 280, 285) (Step 410). Some of the leaf nodes are not visibly rendered on the web page (110, 300), and therefore, are not identified and gathered. The visible content of the leaf nodes (generally 257, and specifically, 280, 265, 270, 275, 280, 285) is identified and gathered.

After gathering all the leaf node contents, (Step 410), the content selection device (105) may then re-compute the spatial coordinates of the bounding boxes of all the nodes (210 through 285, FIG. 2) in the DOM tree (200). This enables the system to gather accurate spatial coordinates of the bounding boxes of all the branches within the DOM tree (200) because the different branches within the DOM tree (200) have bounding boxes with spatial coordinates that are not reliable. In one example, this process may be repeated for each branch within the DOM tree (200). Specifically, as depicted in FIG. 4, a determination as to whether all spatial coordinates for all the nodes are obtained (Step 420). If all spatial coordinates for all the nodes have not been obtained (Step 420, determination NO), then the process loops back to Step 415, and spatial coordinates of the bounding boxes with a branch are re-computed (Step 415).

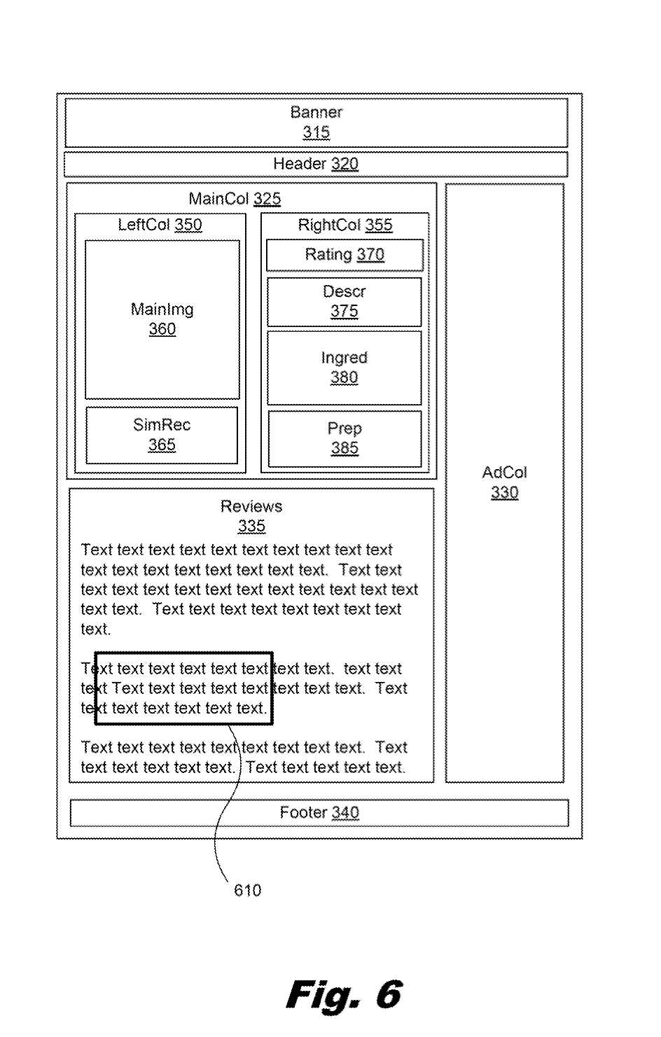

If all spatial coordinates for all the nodes have been obtained (Step 420, determination YES), then the process continues to Step 425 where a list of all nodes (210 through 285) and their respective spatial coordinates are generated. After the list of all nodes (210 through 285) and their respective spatial coordinates are generated (Step 425), the content selection device (105) may then record coordinates of a user's drawing of an approximate region of the web page (110, 300). In one example, the user of the content selection device (105) may provide a user, via a user interface including a display device (145) and a pointer such as a mouse, the ability to casually draw an approximate region (610, FIG. 6) of the web page (110, 300) for selection. FIG. 6 is a diagram of the web page of FIG. 3 in which a user has drawn an approximate region of the web page for selection.

The content selection device (105) then computes the match or matches based on the user's drawing of the approximate region (610, FIG. 6) of the web page (110, 300) and the spatial coordinates of the nodes generated in Step 425 (Step 435). The content selection device (105) may compute any number of potential matches that correspond to the node or nodes included in the user's selected approximate region (610, FIG. 6). In some examples, there may be no matches due to the lack of the user drawing a selection box sufficiently large enough to include a sufficiently large amount of area of a node as defined by the node's spatial coordinates. In other examples, many matches may be found between the user's selected approximate region (610, FIG. 6) and the nodes.

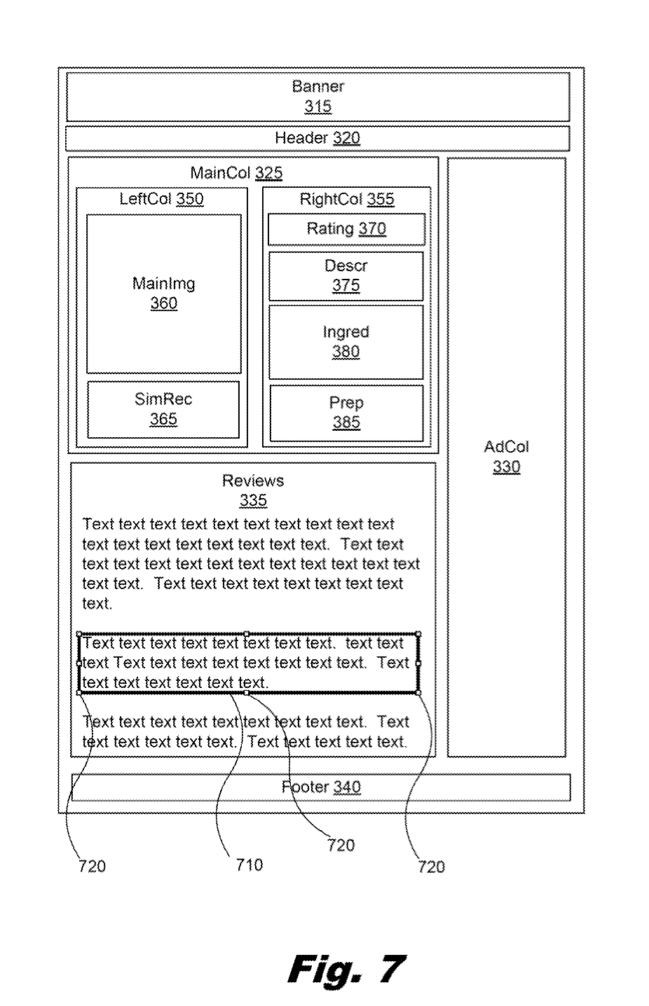

The computation of potential matches that correspond to the node or nodes included in the user's selected approximate region (610, FIG. 6) may be performed by determining the intersection between the user's input coordinates through drawing of the approximate region (610, FIG. 6) and the coordinates of each of the nodes obtained in Steps 410 through 425. In one example, if the intersection between the approximate region (610, FIG. 6) selected by the user is higher than a predetermined threshold ratio of each individual node's bounding box area as defined by their individual spatial coordinates, the node is selected as a corresponding node, and is included in the corresponding region (710, FIG. 7). Such ratio can be set such that, for example, both the width and the height of the intersection is greater than half of the width and half of the height of a given node's bounding box.

A list of corresponding nodes can be generated based on the ratio and the coordinates of the approximate region (610, FIG. 6) as selected by the user. In order to more effectively compute whether a particular node should be included in the corresponding region (710, FIG. 7), certain nodes may be exempt from analysis if its corresponding parent node is included in the corresponding region (710, FIG. 7). In this manner, the nodes are filtered out if the node is a child of a second, parent node in the list, and the child node's bounding box can be included in the parent's bounding box. The filtering work can be performed when adding a new corresponding node to the existing list. If the node's bounding box can be included by an existing node in the list, and it is also a child of the existing node, the new node will not be added to the list and analyzed. Further, in one example, the content selection device (105), in analyzing each of the nodes in the DOM tree (200), may first analyzed parent nodes, and then child nodes in that order to more quickly and effectively determine if the nodes are to be included in the corresponding region (710, FIG. 7). In other words, the content selection device (105) may analyze nodes in the order from left to right in the DOM tree (200) depicted in FIG. 2.

The content selection device (105) then returns the spatial coordinates of all the nodes' bounding boxes in the list (Step 440), and displays the corresponding region or regions to the user. For example, the content selection device (105) may display a corresponding node of the drawn approximate region (610, FIG. 6) on a display device (145) communicatively coupled to the content selection device (105). FIG. 7 is a diagram of the web page of FIGS. 3 and 6 after computation of the corresponding node of the user's drawn approximate region (710), according to one example of principles described herein. As depicted in FIG. 7, the content selection device (105) returned the whole paragraph (710) of which the user selected only a portion. The corresponding node, in this instance, was the remaining text of the paragraph that was not selected by the user in his or her approximation as depicted in FIG. 6 element 610.

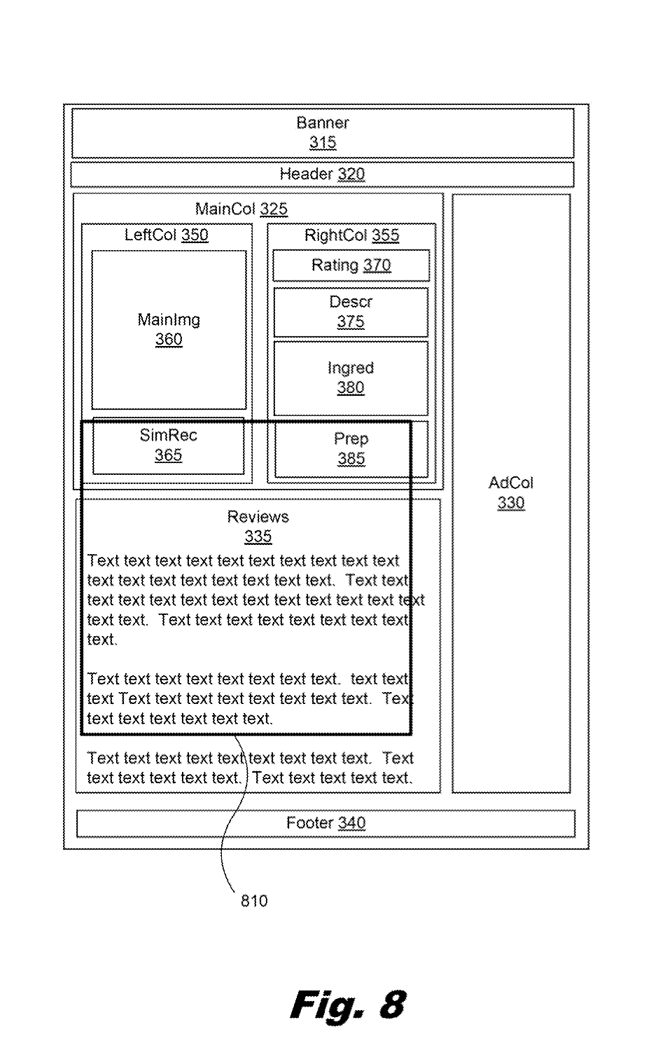

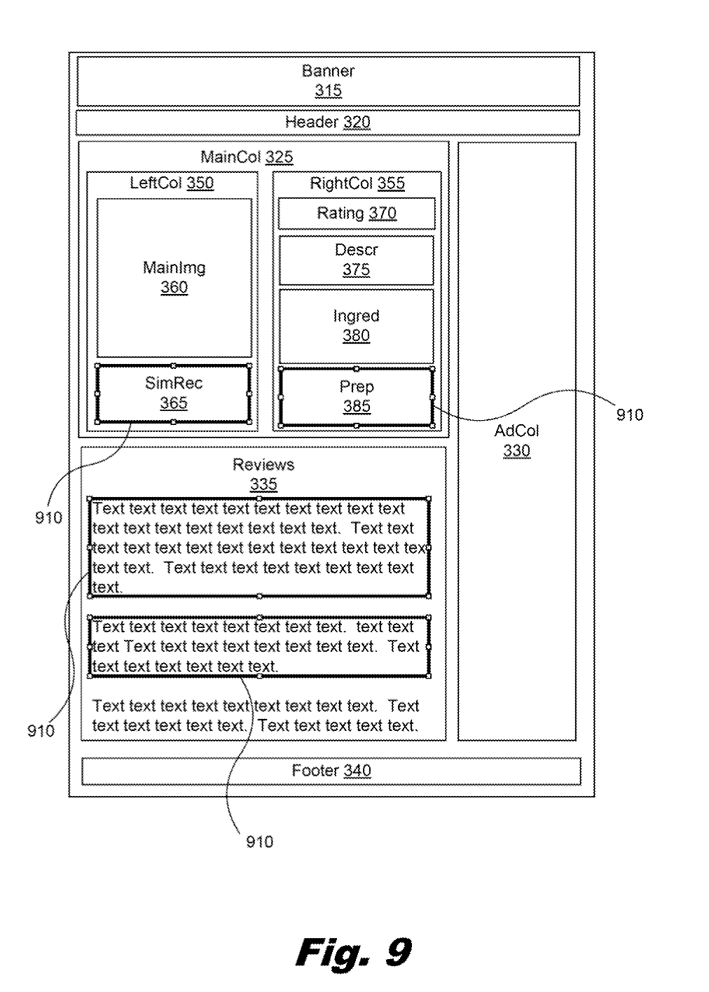

In one example, upon user selection of a portion of the web page, the corresponding region (710) may include a single box surrounding a single element within the web page, the element being the representation of a single node as depicted in FIGS. 6 and 7. However, when a user selects several elements within the web page, the output corresponding to this selection may include the several elements. FIG. 8 is a diagram of the web page of FIG. 3 in which a user has drawn an approximate region (810) of the web page for selection, and FIG. 9 is a diagram of the web page of FIGS. 3 and 8 displaying several corresponding regions (910) after computation of the corresponding nodes of the user's drawn approximate region (810), according to another example of principles described herein. In this example, the several elements within the web page may each have their own individual boxes (910) surrounding them, indicating to the user that that those several elements have been selected. In this example, the user may then include add or subtract elements from the selection by dragging control points of individual boxes (910) to include or remove elements from the selection, as will be discussed in greater detail below.

Although the above example illustrates a situation wherein a user selects a portion of a paragraph, and a match is determined to be the entire paragraph, it will be understood that the match may be, in other user selections, a word, a sentence, a paragraph, the entire text of within that element or node, a single list item, an entire list of items, and numbers of these. One advantage of the present exemplary system and method is that scale and granularity ambiguity issues may be overcome by better determining what portion of text within an element or node the user desires to select.

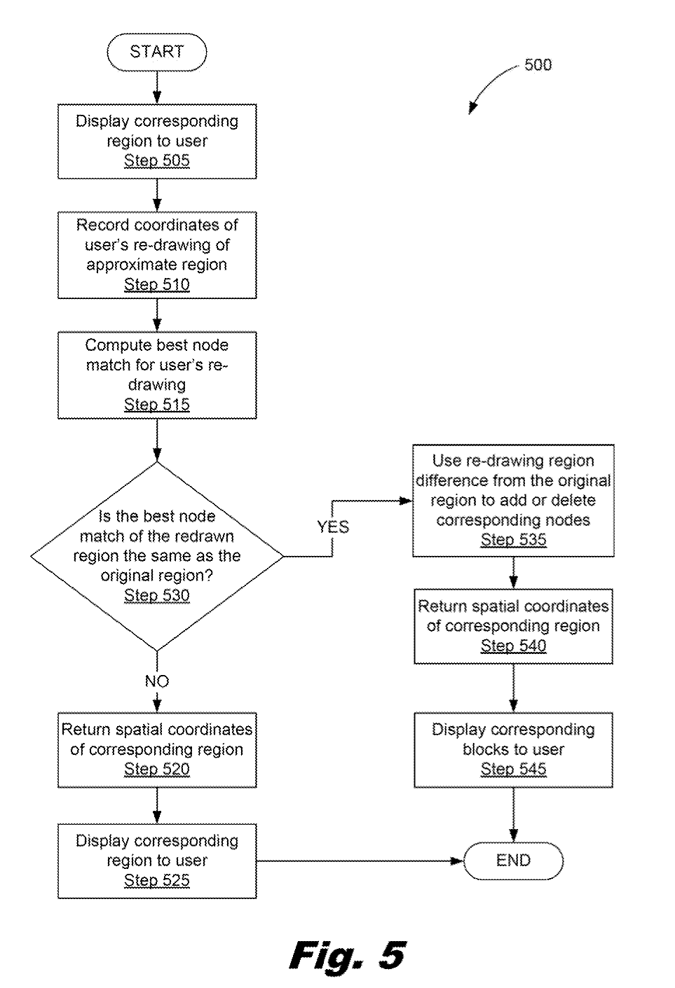

Moving on to FIG. 5, a flow chart depicting an illustrative method for selecting and displaying content of a web page after an initial selection by a user is depicted. After a user has made an initial selection of text within an element or node and the content selection device (105) records the coordinates of the user's drawing, and computes and displays the best match of such a selection (Steps 430 through 445), a user may desire to include more text or restrict portions of the selected text from the best match. As depicted in FIG. 5, the content selection device (105) may display the corresponding region of the web page (110, 300) to a user (Step 505). The user may then resize the region (710, FIG. 7) of the web page (110, 300). In one example, this may be performed by clicking on and dragging a number of control points (720) included on the region (710, FIG. 7). In this manner, the user may include additional portions of the region by dragging, for example, a corner or side of the region (710. FIG. 7) over additional portions of the text. Further, the user may restrict portions of the region (710, FIG. 7) from selection by dragging the control points (720) off of portions of the corresponding region (710, FIG. 7). This manner of addition and subtraction of portions of the matched region (710. FIG. 7) provides for a more effective and user-friendly means of obtaining a portion of the region the user desires to select much like click-and-drag functions of, for example, the WINDOWS® operating system.

After the user resizes the region (710, FIG. 7), the content selection device (105) then records the coordinates of the users resizing of the approximate region desired (Step 510). The content selection device (105) then computes the best node match for the user's resized region (Step 515). In computing the best node match for the user's resizing, an equation can be designed to compute the score for the intersection of the resizing region and each node. In one example, the equation used to compute the score for a given intersection may be, for example:

Score=(3·intersection)−node area

The node with the highest score is the best node after user's dragging of the control points or edges (Step 515). If the best node's match for the resized region is the same as the corresponding region (710, FIG. 7) (Step 530, determination NO), the content selection device (105) uses the difference between the corresponding region (710, FIG. 7) and the user's altered and resized region to add or delete corresponding nodes (Step 535), returns spatial coordinates of the corresponding nodes (Step 540), and displays the new corresponding regions to the user (Step 545) including the added or deleted nodes. In this manner, a user's attempt to add or subtract nodes in is still addressed by the content selection device (105) even if the user does not drag the control points (720. FIG. 7) to add or subtract a number of nodes in their entirety. If the best node's match for the resized region is the same as the corresponding region (710, FIG. 7) (Step 530, determination YES), then the content selection device (105) returns the spatial coordinates of the corresponding region (710, FIG. 7) (Step 520), and displays the corresponding region (710, FIG. 7) to the user (Step 525).

The specification and figures describe a system and method of selecting content within a web page. The method may include determining spatial coordinates of a plurality of nodes within the web page, recording coordinates of a drawn portion of the web page, determining the best node match for the drawn portion of the web page based on the spatial coordinates of the nodes, and displaying the best node match. This method of selecting content within a web page may have a number of advantages. First, the user does not need to select portions of the web page precisely. In an example, the content selection device (105) can determine a best match of selected text with only a casual, non-precise, and approximate selection by the user. Second, the selections correspond to nodes included in the DOM tree, and are, therefore, more easily utilized in application such as web printing, block level based web page searching, web page segmentation, among others. Third, the present system and method overcomes scale and granularity issues prevalent in other methods such as a screen-shot based solution, a click-based solution, and a gesture-based solution. Fourth, the click-and-drag interface is an interface known and used by most users, and, therefore, the interface proves to be more intuitive for a user.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of selecting content within a web page (110, 300) comprising:
determining, with a processor (125), spatial coordinates of a plurality of nodes (210 through 285) within the web page (110, 300);
recording coordinates of a drawn portion (610) of the web page (110, 300); and
determining, with the processor (125), a number of corresponding regions (710, 910) for the drawn portion (610) of the web page (110, 300) based on the spatial coordinates of the nodes (210 through 285).

2. The method of claim 1, further comprising displaying the corresponding regions (710, 910).

3. The method of claim 1, in which determining spatial coordinates of a plurality of nodes (210 through 285) within the web page (110, 300) comprises:
rendering the web page (110, 300);
crawling a document object model (DOM) (200) of the web page (119, 300);
gathering a plurality of leaf node (260 through 285) contents;
re-computing spatial coordinates of bounding boxes in the document object model (DOM) (200) of the web page (110 300) using the leaf node (260 through 285) contents; and
generating a list of the plurality of nodes (210 through 285) and their respective spatial coordinates.

4. The method of claim 3, in which re-computing spatial coordinates of bounding boxes in the document object model (DOM) (200) of the web page (110, 300) using the leaf node (260 through 285) contents comprises:
determining whether all spatial coordinates for all nodes (210 through 285) within the document object model (DOM) (200) have been obtained; and
if all spatial coordinates for all nodes (210 through 285) have not been obtained, then re-computing spatial coordinates of bounding boxes in all the branches of the document object model (DOM) (200) of the web page (110, 300) using the leaf node (260 through 285) contents.

5. The method of claim 1, further comprising:
displaying the corresponding regions (710, 910);
recording coordinates of a resized portion of the web page (110, 300); and
determining the best node match for the resized portion of the web page (110, 300) based on the spatial coordinates of the nodes (210 through 285).

6. The method of claim 5, in which recording coordinates of a resized portion of the web page (110, 300) comprises:
obtaining coordinates of a best node match of the web page (110, 300) from a click and drag operation performed on a number of control points (720).

7. A system for selecting content within a web page (110, 300) comprising:
a memory (130); and
a processor (125) communicatively coupled to the memory (130), in which the processor (125):
determines spatial coordinates of a plurality of nodes (210 through 285) within the web page (110, 300);
records coordinates of a drawn portion (610) of the web page (110, 300) in a memory (130); and
determines a number of corresponding regions (710, 910) for the drawn portion (610) of the web page (110, 300) based on the spatial coordinates of the nodes (210 through 285).

8. The system of claim 7, further comprising a display device (145) to display the corresponding regions (710, 910).

9. The system of claim 7, in which the processor (125) further:
renders the web page (110, 300) obtained from a web page server;
crawls a document object model (DOM) (200) of the web page (110, 300);
gathers a plurality of leaf node (260 through 285) contents;
re-computes spatial coordinates of bounding boxes in the document object model (DOM) (200) of the web page (110, 300) using the leaf node (260 through 285) contents; and
generates a list of the plurality of nodes (210 through 285) and their respective spatial coordinates.

10. The system of claim 9, in which the processor (125) further:
determines whether all spatial coordinates for all nodes (210 through 285) within the document object model (DOM) (200) have been obtained; and
if all spatial coordinates for all nodes (210 through 285) have not been obtained, then re-computes spatial coordinates of bounding boxes in all the branches of the document object model (DOM) (200) of the web page (110, 300) using the leaf node (260 through 285) contents.

11. The system of claim 7, in which the processor (125) further:
displays the corresponding regions (710, 910);
records coordinates of a resized portion of the web page (110, 300) in a memory (130); and
determines the best node match for the resized portion of the web page (110, 300) based on the spatial coordinates of the nodes (210 through 285).

12. The system of claim 11, in which the processor (125) further obtains coordinates of a best node match of the web page (110, 300) from a click and drag operation performed on a number of control points (720).

13. The system of claim 9, in which the processor (125) and web page server are communicatively coupled via a network.

14. A method for adding and subtracting content within a web page (110, 300) comprising:
with a processor (125), determining spatial coordinates of a plurality of nodes (210 through 285) within the web page (110, 300);
recording coordinates of a drawn portion (610) of the web page (110, 300) in a memory (130);
determining, with the processor (125), a number of corresponding regions (710, 910) for the drawn portion (610) of the web page (110, 300) based on the spatial coordinates of the nodes (210 through 285);
displaying the corresponding regions (710, 910):
recording coordinates of a resized portion of the web page (110, 300) in a memory (130); and
determining, with the processor (125), the best node match (710) for the resized portion of the web page (110, 300) based on the spatial coordinates of the nodes (210 through 285).

15. The method of claim 14, in which recording coordinates of a resized portion of the web page (110, 300) in a memory (130) comprises obtaining coordinates of a best node match of the web page (110, 300) from a click and drag operation performed on a number of control points (720).
